(19) United States
(12) Patent Application Publication
(10) Pub. No.: US 2025/0293579 A1
(43) Pub. Date: Sep. 18, 2025

(54) SWITCHING CONTROL CIRCUIT AND POWER SUPPLY CIRCUIT

(71) Applicant: FUJI ELECTRIC CO., LTD., Kawasaki-shi (JP)

(72) Inventor: Yoshinori KOBAYASHI, Matsumoto-city (JP)

(73) Assignee: FUJI ELECTRIC CO., LTD., Kawasaki-shi (JP)

(21) Appl. No.: 19/041,782

(22) Filed: Jan. 30, 2025

(30) Foreign Application Priority Data
Mar. 12, 2024 (JP) 2024-038359

(51) Int. Cl. H02M 1/00; H02M 3/00; H02M 3/335

(52) U.S. Cl. CPC H02M 1/0035; H02M 1/0019; H02M 3/01; H02M 3/33571

(57) ABSTRACT

A switching control circuit for controlling a power supply circuit, including: a comparator circuit comparing each of a first voltage and a second voltage with a feedback voltage corresponding to an output voltage; a first adjustment circuit adjusting the first voltage; and a drive signal output circuit outputting a drive signal to operate the power supply circuit in a normal mode and in a burst mode, respectively in response to a state of the load entering a light-load state and a light-load state. The drive signal output circuit outputs the drive signal to gradually increase an ON period of each of the first transistor and the second transistor, in response to the feedback voltage exceeding the first voltage, and to gradually reduce the ON period of each of the first transistor and the second transistor, in response to the feedback voltage dropping below the second voltage.

### CROSS-REFERENCE TO RELATED APPLICATIONS

The present application claims priority pursuant to 35 U.S.C. § 119 from Japanese patent application number 2024-038359 filed on Mar. 12, 2024, the entire disclosure of which is hereby incorporated by reference herein.

### BACKGROUND

### Technical Field

The present disclosure relates to a switching control circuit and a power supply circuit.

### Description of the Related Art

Current resonant DC-DC converters generally operate in a normal mode of continuously driving a switching device when a load is in a heavy load state, and transition to a burst mode in response to the load entering a light load state. Such DC-DC converters include those transitioning to multiple states to operate in the burst mode (for example, International Publication WO 2020/017163 and Japanese Patent Application Publication No. 2022-116947).

Transitions among multiple states in the burst mode are generally determined based on a feedback voltage. Then, the feedback voltage varies based on the circuit constant and the output voltage of the circuit that generates the feedback voltage in the DC-DC converter. However, it is difficult to change the feedback voltage by changing the circuit constant, to thereby change the operation of the DC-DC converter in the burst mode, for example.

### SUMMARY

An aspect of the present disclosure is a switching control circuit for controlling a power supply circuit that generates an output voltage at a target level on a secondary side from an input voltage thereof, the power supply circuit including a transformer including a primary coil, a secondary coil, and an auxiliary coil, a first transistor and a second transistor that are configured to control a current of the primary coil, and a first capacitor that forms a resonant circuit with the primary coil, the switching control circuit being configured to control switching of the first transistor and the second transistor, the switching control circuit comprising: a comparator circuit configured to compare each of a first voltage and a second voltage lower than the first voltage, with a feedback voltage corresponding to the output voltage; a first adjustment circuit configured to adjust a level of the first voltage; and a drive signal output circuit configured to output a drive signal to operate the power supply circuit in a normal mode, in response to a state of a load of the power supply circuit entering a heavy-load state, and output the drive signal to operate the power supply circuit in a burst mode, in response to the state of the load entering a light-load state, wherein the drive signal output circuit enters a first state of outputting the drive signal to gradually increase an ON period of each of the first transistor and the second transistor, in response to the feedback voltage exceeding the first voltage, and enters a second state of outputting the drive signal to gradually reduce the ON period of each of the first transistor and the second transistor, in response to the feedback voltage dropping below the second voltage.

Another aspect of the present disclosure is a power supply circuit configured to generate an output voltage at a target level on a secondary side from an input voltage thereof, the power supply circuit comprising: a transformer including a primary coil, a secondary coil, and an auxiliary coil; a first transistor and a second transistor that are configured to control a current of the primary coil; a first capacitor forming a resonant circuit with the primary coil; and a switching control circuit configured to control switching of the first transistor and the second transistor, wherein the switching control circuit includes a comparator circuit configured to compare each of a first voltage and a second voltage lower than the first voltage, with a feedback voltage corresponding to the output voltage, a first adjustment circuit configured to adjust a level of the first voltage, and a drive signal output circuit configured to output a drive signal to operate the power supply circuit in a normal mode, in response to a state of a load of the power supply circuit entering a heavy-load state, and output the drive signal to operate the power supply circuit in a burst mode, in response to the state of the load entering a light-load state; and the drive signal output circuit enters a first state of outputting the drive signal to gradually increase an ON period of each of the first transistor and the second transistor, in response to the feedback voltage exceeding the first voltage, and enters a second state of outputting the drive signal to gradually reduce the ON period of each of the first transistor and the second transistor, in response to the feedback voltage dropping below the second voltage.

### BRIEF DESCRIPTION OF THE DRAWINGS

FIG. 1 is a diagram illustrating a configuration example of a switching power supply circuit 10.

FIG. 2 is a diagram illustrating a configuration example of a control IC 42a.

FIG. 3 is a diagram illustrating the state transitions of a drive signal output circuit 200.

FIG. 4 is a diagram illustrating a driving pattern in a “normal mode”.

FIG. 5 is a diagram illustrating a driving method in a “normal mode”.

FIG. 6 is a diagram summarizing a driving method in a “normal mode”.

FIG. 7 is a diagram illustrating a driving pattern in a “burst mode”.

FIG. 8 is a diagram illustrating a driving method in a “state D”.

FIG. 9 is a diagram illustrating a relationship between a voltage Vbo, and a predetermined number of times N and an amount of change ΔONW.

FIG. 10 is a diagram illustrating a driving method in a “state A”.

FIG. 11 is a diagram summarizing a driving method in a “state A”.

FIG. 12 is a diagram illustrating a relationship between a voltage Vbo and threshold values Thvw_h and Thvw_l.

FIG. 13 is a diagram illustrating a driving method in a “state B”.

FIG. 14 illustrates operation waveforms immediately after shifting from a “normal mode” to a “burst mode”.

FIG. 15 is a diagram illustrating a driving pattern in a switching operation period in a “burst mode.”.

FIG. 16A is a diagram illustrating an operation of a control IC 40a in a “burst mode”.

FIG. 16B is a diagram illustrating an operation of a control IC 40a in a “burst mode”.

FIG. 17 is a diagram illustrating a configuration example of a control IC 40b.

FIG. 18 is a diagram illustrating a configuration example of a control IC 40c.

FIG. 19 is a diagram illustrating a configuration example of a control IC 40d.

FIG. 20 is a diagram illustrating a configuration example of a control IC 40e.

FIG. 21 is a diagram illustrating a configuration example of a control IC 40f.

### DETAILED DESCRIPTION

At least following matters will become apparent from the descriptions of the present description and the accompanying drawings. Hereinafter, embodiments of the present disclosure will be described with reference to the drawings. The same or equivalent constituent elements, members, and the like illustrated in the drawings are given the same reference numerals, and repetitive description is omitted as appropriate.

### Embodiments

### <<<Outline of Switching Power Supply Circuit 10>>>

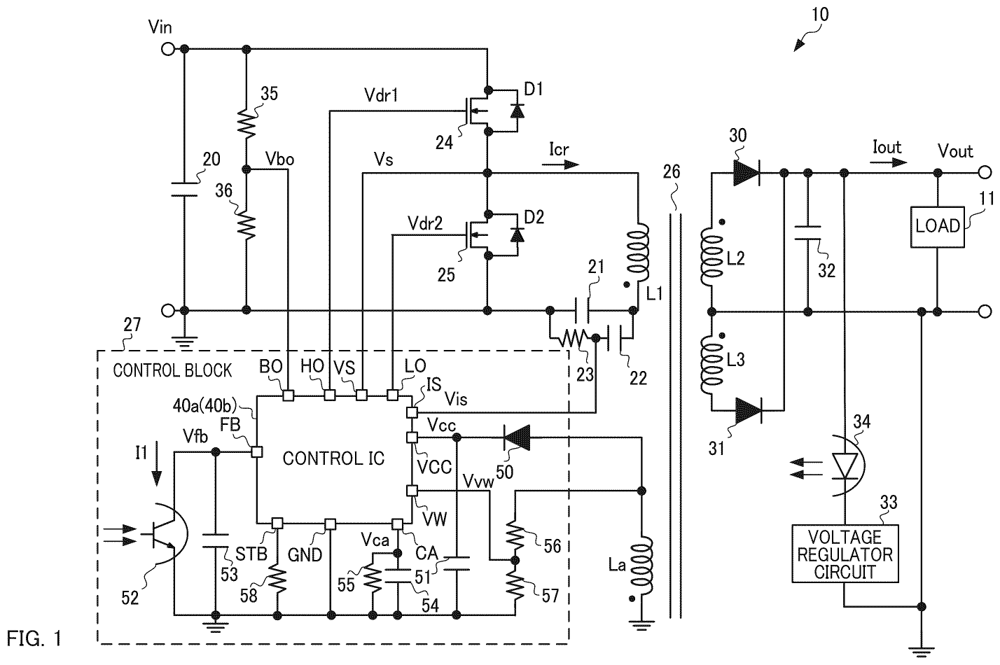

FIG. 1 is a diagram illustrating a configuration example of a switching power supply circuit 10, which is an embodiment of the present disclosure. The switching power supply circuit 10 is an LLC current resonance power supply circuit that generates, at a load 11, an output voltage Vout at a target level from a predetermined input voltage Vin.

The switching power supply circuit 10 includes capacitors 20, 21, 22, and 32, a resistor 23, N-channel metal-oxide-semiconductor (NMOS) transistors 24, 25, a transformer 26, a control block 27, diodes 30 and 31, a voltage regulator circuit 33, and a light-emitting diode 34, and resistors 35 and 36.

The capacitor 20 stabilizes a voltage between a power supply line that receives the input voltage Vin and a ground line on a ground side, to thereby remove noise and the like. The input voltage Vin is a direct-current (DC) voltage at a predetermined level. The capacitor 21 is a so-called resonant capacitor configuring a resonant circuit with a leakage inductance between a primary coil L1 and secondary coils L2 and L3. The capacitor 21 corresponds to a “first capacitor”.

The capacitor 22 and the resistor 23 configure a detection circuit that shunts and detects a resonant current Icr flowing through the capacitor 21. The capacitor 22 and the resistor 23, which are connected in series, are connected in parallel with the capacitor 21.

The resistor 23 generates a voltage Vis, based on the current obtained by shunting the resonant current Icr. Accordingly, the voltage Vis results in a voltage corresponding to the resonant current Icr. Note that the resonant current Icr when flowing in the direction given in FIG. 1 is referred to as positive resonant current Icr, and in this case, it is assumed that the voltage Vis is a positive voltage. When the resonant current Icr flows in the direction of the arrow, in other words, when the resonant current Icr flows in the order of the primary coil L1, the capacitor 22, and the resistor 23, the direction of the resonant current Icr is positive. Meanwhile, when the resonant current Icr flows in the direction opposite to the direction of the arrow, in other words, when the resonant current Icr flows in the order of the resistor 23, the capacitor 22, and the primary coil L1, the direction of the resonant current Icr is negative.

The NMOS transistor 24 is a high-side power transistor, and the NMOS transistor 25 is a low-side power transistor. Specifically, the NMOS transistors 24, 25 are connected in series between a node to receive the input voltage Vin and a node to receive a ground voltage. In an embodiment of the present disclosure, the NMOS transistors 24, 25 are used as switching devices, however, for example, P-channel metal-oxide-semiconductor (PMOS) transistors or bipolar transistors may be used. The NMOS transistor 24 corresponds to a “first transistor”, and the NMOS transistor 25 corresponds to a “second transistor”.

The transformer 26 includes the primary coil L1, the secondary coils L2 and L3, and an auxiliary coil La. The primary coil L1, the secondary coils L2 and L3, and the auxiliary coil La are insulated from one another. In the transformer 26, voltages are generated at the secondary coils L2 and L3 on the secondary side and the auxiliary coil La, according to variation in the voltage across the primary coil L1 on the primary side.

The primary coil L1 has one end to which the source of the NMOS transistor 24 and the drain of the NMOS transistor 25 are connected, and the other end to which the source of the NMOS transistor 25 is connected through the capacitor 21.

Accordingly, upon start of switching of the NMOS transistors 24, 25, each of the voltages at the secondary coils L2 and L3 and the auxiliary coil La varies. Note that the primary coil L1 and the secondary coils L2 and L3 are electromagnetically connected with different polarities, and the primary coil L1 and the auxiliary coil La are electromagnetically connected with the same polarity.

The control block 27 is a circuit block that controls switching of the NMOS transistors 24, 25, which will be described later in detail.

The diodes 30 and 31 rectify the voltages at the secondary coils L2 and L3, and the capacitor 32 smooths the rectified voltages. As a result, the output voltage Vout having been smoothed is generated at the capacitor 32. Note that the output voltage Vout results in a direct-current voltage at the target level.

The voltage regulator circuit 33 generates a constant DC voltage, and is configured using a shunt regulator, for example.

The light emitting diode 34 is an element that emits light with an intensity corresponding to a difference between the output voltage Vout and the output of the voltage regulator circuit 33, and configures a photocoupler with a phototransistor 52 which will be described later. In an embodiment of the present disclosure, when the level of the output voltage Vout increases, the intensity of the light from the light emitting diode 34 increases.

The resistors 35 and 36 configure a voltage divider circuit that divides the input voltage Vin, and a voltage Vbo is generated at the connection node between the resistors 35 and 36.

### <<<Control Block 27>>>

The control block 27 includes a control IC 40a, a diode 50, capacitors 51, 53, and 54, a phototransistor 52, and resistors 55, 56, 57, and 58. Note that the control IC 40a corresponds to a “switching control circuit”.

The control IC 40a is an integrated circuit that controls switching of the NMOS transistors 24, 25, and has terminals VCC, GND, FB, IS, CA, HO, LO, VS, BO, VW, and STB.

The terminal VCC is a terminal to receive a power supply voltage Vcc to operate the control IC 40a. The terminal VCC is connected to a capacitor 51 having one end that is grounded and the cathode of the diode 50. Then, the capacitor 51 is charged with the voltage from the auxiliary coil La of the transformer 26, resulting in the voltage Vcc. Note that the control IC 40a is activated upon application of the divided voltage of the input voltage Vin that is obtained by rectifying an alternating current (AC) input through a terminal (not illustrated), and after being activated, the control IC 40a operates based on the power supply voltage Vcc.

The terminal GND is a terminal to receive the ground voltage, and, for example, the housing of a device where the switching power supply circuit 10 is provided or the like is connected thereto.

The terminal FB is a terminal at which a feedback voltage Vfb corresponding to the output voltage Vout is generated, and the phototransistor 52 and the capacitor 53 are connected thereto. The phototransistor 52 passes, from the terminal FB to the ground, a bias current I1 having a magnitude corresponding to the intensity of the light from the light-emitting diode 34, and the capacitor 53 is provided to remove noise between the terminal FB and the ground. Accordingly, the phototransistor 52 operates as a transistor that generates a sink current.

The terminal IS is a terminal to detect the current value of the resonant current of the primary coil L1. Here, the voltage corresponding to the current value of the resonant current of the primary coil L1 is generated at the node at which the capacitor 22 and the resistor 23 are connected. Thus, the voltage Vis corresponding to the current value of the resonant current of the primary coil L1 is applied to the terminal IS.

The terminal CA is a terminal to receive a voltage Vca which is generated based on the resonant current of the primary coil L1 and corresponds to the input power of the switching power supply circuit 10. Note that the capacitor 54 and the resistor 55 are connected to the terminal CA, which will be described later in detail.

The terminal HO is a terminal from which a drive signal Vdr1 to drive the NMOS transistor 24 is outputted, and the gate of the NMOS transistor 24 is connected thereto.

The terminal LO is a terminal from which the drive signal Vdr2 to drive the NMOS transistor 25 is outputted, and is connected to the gate of the NMOS transistor 25.

The terminal VS is a terminal to receive a voltage at the connection node at which the source terminal of the NMOS transistor 24 and the drain terminal of the NMOS transistor 25 are connected, and receive the input voltage Vin upon turning on of the NMOS transistor 24, and receive the ground voltage upon turning on of the NMOS transistor 25.

The potential of a voltage Vs at the terminal VS is the reference potential of the output voltage of a bootstrap circuit (not illustrated) for turning on the NMOS transistor 24 when the input voltage Vin is being applied to the terminal VS.

The terminal BO is a terminal to receive the voltage Vbo generated by the resistors 35 and 36.

Terminal VW is a terminal to receive Vvw obtained by dividing the voltage at the auxiliary coil La with the resistors 56 and 57.

The terminal STB is a terminal to control a control circuit 300 (described later) in the manufacturing stage of the control IC 40a. Specifically, the terminal STB constitutes an I2C interface with the terminal BO, and a data signal at the I2C interface is inputted to the terminal STB. Meanwhile, a clock signal at the I2C interface is inputted to the terminal BO. Note that when the control IC 40a is incorporated in the switching power supply circuit 10, the resistor 58 is connected to the terminal STB. Note that the terminal STB corresponds to a “first resistor”, and the resistor 58 corresponds to a “resistor”.

<<<Details of Control IC 40a>>>

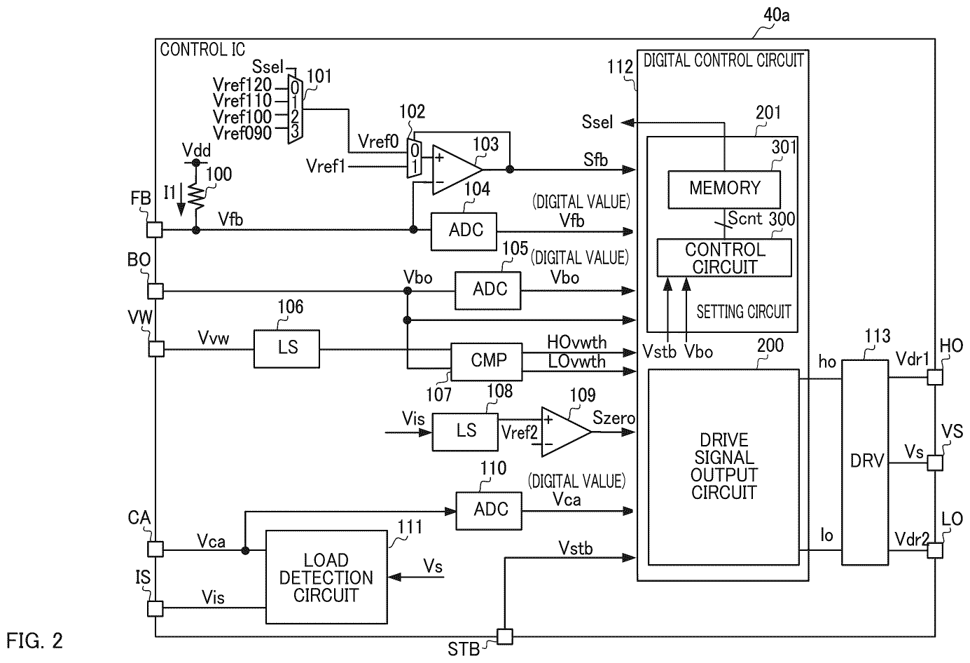

FIG. 2 is a diagram illustrating an example of the control IC 40a. The control IC 40a is the integrated circuit that drives the NMOS transistors 24, 25 based on the state that transitions according to the voltage applied to each of the terminals. The control IC 40a includes a resistor 100, selectors 101 and 102, comparators 103 and 109, analog-to-digital converter circuits (ADCs) 104, 105, and 110, level shifter circuits (LSs) 106 and 108, a comparator circuit (CMP) 107, a load detection circuit 111, a digital control circuit 112, and a driver circuit (DRV) 113. Note that the terminals VCC and GND are omitted here for convenience.

The resistor 100 generates the feedback voltage Vfb based on the bias current I1 from the phototransistor 52. Note that the resistor 100 has one end to receive a predetermined voltage Vdd, and the other end connected to the terminal FB. Accordingly, the feedback voltage Vfb generated at the terminal FB is given by Expression (1): where “R” is a resistance value of the resistor 100.

Vfb=Vdd−R×I1 (1)

As described above, in an embodiment of the present disclosure, the current value of the bias current I1 increases with a rise in the output voltage Vout. Accordingly, when the output voltage Vout rises, the feedback voltage Vfb drops.

The selector 101 adjusts the level of the reference voltage Vref0 to any one of the reference voltages Vref120, Vref110, Vref100, and Vref090 that are outputted based on a signal Ssel from the digital control circuit 112 (described later). Specifically, the selector 101 adjusts the reference voltage Vref0 to the reference voltage Vref120 when the signal Ssel is “0”. Further, the selector 101 adjusts the reference voltage Vref0 to the reference voltage Vref110, Vref100, and Vref090 when the signal Ssel is “1”, “2”, and “3”, respectively. Note that the reference voltage Vref0 is used by the comparator 103 (described later) as a higher reference voltage. By way of example, the reference voltage Vref120 is 1.2V, the reference voltage Vref110 is 1.1 V the reference voltage Vref100 is 1.0 V and the reference voltage Vref090 is 0.9 V Further, the selector 101 corresponds to a “first adjustment circuit”.

The selector 102 applies the reference voltage Vref0 or the reference voltage Vref1 lower than the reference voltage Vref0, to the comparator 103, based on the logic level of a signal Sfb outputted by the comparator 103. Specifically, when the comparator 103 outputs the signal Sfb at low-level (hereinafter referred to as low or low level), the selector 102 applies the reference voltage Vref0 to the non-inverting input of the comparator 103. Further, when the comparator 103 outputs the signal Sfb at a high-level (hereinafter referred to as high, high level), the selector 102 applies the reference voltage Vref 1 to the non-inverting input of the comparator 103.

The comparator 103 is used when the drive signal output circuit 200 (described later) operates in an operation mode of intermittently driving the NMOS transistors 24, 25 (i.e., “burst mode”), and detects whether the feedback voltage Vfb is high. Further, the comparator 103 compares the reference voltage Vref0 and the reference voltage Vref1 with the feedback voltage Vfb.

Specifically, in response to the output voltage Vout dropping and the feedback voltage Vfb exceeding the reference voltage Vref0, the comparator 103 outputs the high signal Sfb. Meanwhile, in response to the output voltage Vout rising and the feedback voltage Vfb dropping below the reference voltage Vref1, the comparator 103 outputs the low signal Sfb. Note that the comparator 103 corresponds to a “comparator circuit”, the reference voltage VREF0 corresponds to a “first voltage”, and the voltage Vref1 corresponds to a “second voltage”.

It is assumed in an embodiment of the present disclosure that the comparator 103 outputs the signal Sfb, but the drive signal output circuit 200 (described later) may generate the signal Sfb, based on the feedback voltage Vfb, which is a digital value from the analog-to-digital converter circuit 104.

The analog-to-digital converter circuit (ADC) 104 converts the feedback voltage Vfb at the terminal FB into a digital value, to output a resultant. The feedback voltage Vfb converted into a digital value is at least used for the drive signal output circuit 200 (described later) to output drive signals ho, lo (described later) in an operation mode of continuously driving the NMOS transistors 24, 25 (i.e., “normal mode”). Note that the analog-to-digital converter circuit 104 stops operating when the drive signal output circuit 200 operates in the “burst mode”.

The analog-to-digital conversion circuit (ADC) 105 converts the voltage Vbo at the terminal BO into a digital value, to output a resultant. The voltage Vbo converted into the digital value is used for the drive signal output circuit 200 (described later) to output the drive signals ho, lo (described later) at least in so-called soft start and soft end.

The level shifter circuit (LS) 106 level-shifts the voltage Vvw.

The comparator circuit (CMP) 107 compares magnitudes between the level-shifted voltage Vvw and the threshold values Thvw_h and Thvw_l according to the voltage Vbo, to output pulse signals LOvwth and HOvwth. Specifically, the comparator circuit 107 outputs the pulse signal HOvwth to turn off the NMOS transistor 24, in response to the level-shifted voltage Vvw dropping below the threshold value Thvw_h. Meanwhile, the comparator circuit 107 outputs the pulse signal LOvwth to turn off the NMOS transistor 25, in response to the level-shifted voltage Vvw exceeding the threshold value Thvw_l.

The level shift circuit (LS) 108 level-shifts the voltage Vis.

The comparator 109 compares the level-shifted voltage Vis with the reference voltage Vref2, to thereby detect the polarity of the resonant current Icr, and outputs a signal Szero. Note that the reference voltage Vref2 is equal to the voltage obtained by level-shifting the voltage Vis at the time when the resonant current Icr reaches zero. Further, the comparator 109 detects the timing at which the resonant current Icr reaches zero, and the logic level of the signal Szero changes at the timing at which the resonant current Icr reaches zero. Note that the comparator 109 corresponds to a “detection circuit”, and the signal Szero corresponds to a “result of detection”.

The analog-to-digital converter circuit (ADC) 110 converts the voltage Vca at the terminal CA into a digital value, to output a resultant. The voltage Vca converted into the digital value is used by the drive signal output circuit 200 (described later), when the mode is switched between the “normal mode” and the “burst mode”.

The load detection circuit 111 detects whether the load 11 is in the light load state or the heavy load state load, based on the voltage that is applied to the terminal IS and corresponds to the power consumption of the load 11 (in other words, the voltage Vis corresponding to the resonant current flowing through the resonant circuit). Here, the power consumption of the load 11 is larger when the load 11 is in the heavy load state than when the load 11 is in the light load state. Accordingly, the voltage Vis applied to the terminal IS indicates the voltage corresponding to the power consumption of the load 11, and thus when the voltage Vis is lower than a predetermined value, the load detection circuit 111 outputs the voltage Vca indicating that the load 11 is in the light load state.

Meanwhile, when the voltage Vis is higher than the predetermined value, the load detection circuit 111 outputs the voltage Vca indicating that the load 11 is in the heavy load state. The heavier the state of the load 11 is, the higher the voltage Vca is.

Note that the phrase “the load 11 is in the heavy load state” indicates the case in which the current value of the load current Iout flowing through the load 11 is equal to or larger than a predetermined value (e.g., 1 A), for example. Further, the phrase “the load 11 is in the light load state” indicates the case in which the current value of the load current Iout flowing through the load 11 is smaller than the predetermined value (e.g., 1 A), for example. Further, the phrase “the load 11 is in no load state” indicates the case in which the current value of the load current Iout flowing through the load 11 is extremely small or 0 (zero) A. A description is given such that the current value of the load current Iout to determine whether the load 11 is in the heavy load state or light load state is 1 A, for example; however, this current value may be set to various values. Note that the load detection circuit 111 corresponds to a “resonant current amount detection circuit”.

The digital control circuit 112 outputs the drive signals ho, lo and the signal Ssel, based on a plurality of signals, such as the signal Sfb and the like, and digital values. The digital control circuit 112 includes the drive signal output circuit 200 and a setting circuit 201.

The drive signal output circuit 200 outputs drive signals ho, lo to operate the switching power supply circuit 10 in the “burst mode”, when the load 11 is in the light load state, which will be described later in detail. Meanwhile, the drive signal output circuit 200 outputs the drive signals ho, lo to operate the switching power supply circuit 10 in the “normal mode”, when the load 11 is in the heavy load state.

The setting circuit 201 receives data indicating the level of the reference voltage Vref0. Specifically, the setting circuit 201 receives data from the I2C interface, which includes a clock signal from the terminal BO and a data signal from the terminal STB. The setting circuit 201 includes the control circuit 300 and a memory 301.

The control circuit 300 outputs a control signal Scnt, based on a clock signal from the terminal BO and the data signal from the terminal STB, and writes data into the memory 301. The memory 301 outputs the signal Ssel, based on the written data. Then, the selector 101 adjusts the level of the reference voltage Vref0, based on the signal Ssel. Note that the data corresponds to “first data”.

The driver circuit (DRV) 113 outputs the drive voltages Vdr1 and Vdr2, which drive the NMOS transistors 24, 25, respectively. Specifically, in response to the drive signal output circuit 200 outputting the high drive signal ho, the driver circuit 113 outputs the drive voltage Vdr1 to turn on the NMOS transistor 24, and in response to the drive signal output circuit 200 outputting the low drive signal ho, the driver circuit 113 outputs the drive voltage Vdr1 to turn off the NMOS transistor 24. Further, in response to the drive signal output circuit 200 outputting the high drive signal lo, the driver circuit 113 outputs the drive voltage Vdr2 to turn on the NMOS transistor 25, and in response to the drive signal output circuit 200 outputting the low drive signal lo, the driver circuit 113 outputs the drive voltage Vdr2 to turn off the NMOS transistor 25.

### ===State Transition of Drive Signal Output Circuit 200===

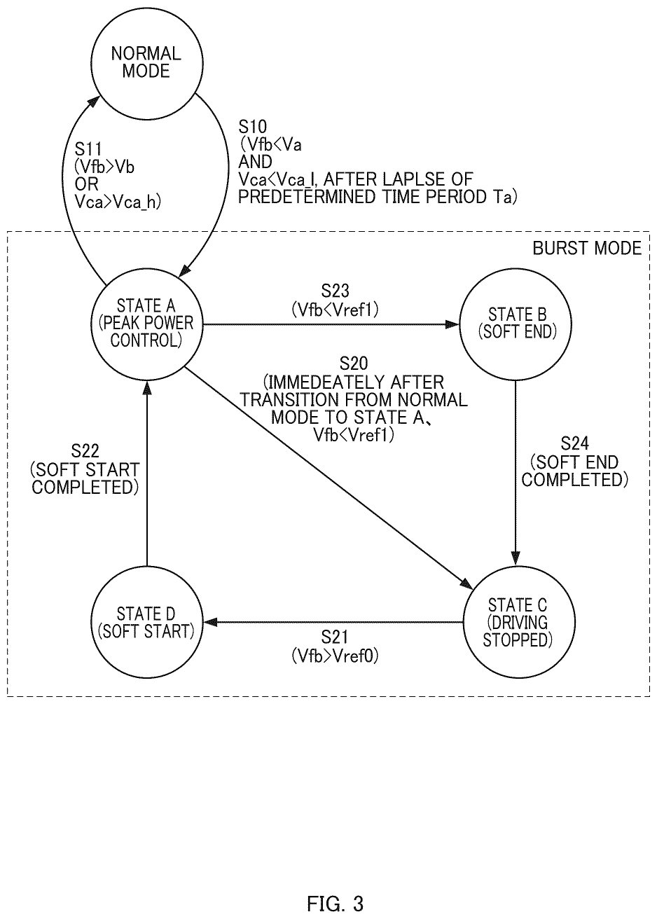

FIG. 3 illustrates the state transitions of the drive signal output circuit 200. Note that FIG. 3 is a diagram illustrating how the state of the drive signal output circuit 200 transitions, and thus how the drive signal output circuit 200 outputs the drive signals ho, lo in each state will be described later. Further, “State A” to “State D” indicate the states of the drive signal output circuit 200 when the switching power supply circuit 10 operates in “the burst mode”. First, it is assumed that the control IC 40a is operating the switching power supply circuit 10 in the “normal mode.”.

In the “normal mode”, in response to the load 11 entering the light load state, the feedback voltage Vfb dropping below a voltage Va, and the predetermined time period Ta having elapsed with the voltage Vca remaining lower than a threshold value Vca_l, the state of the drive signal output circuit 200 changes from the “normal mode” to “State A”, which is the state in “the burst mode” (process S10). Further, it is assumed in an embodiment of the present disclosure that the state of the drive signal output circuit 200 enters “State A”, based on the feedback voltage Vfb and the voltage Vca, but the state of the drive signal output circuit 200 may enter “State A” on the condition that the predetermined time period Ta has elapsed with the voltage Vca remaining lower than the threshold value Vca_l. Note that the voltage Va corresponds to a “fourth voltage”, and the magnitude of the resonant current when the voltage Vca reaches the threshold value Vca_l corresponds to a “second predetermined amount”.

“State A”, which will be described later in detail, is a state in which the drive signal output circuit 200 outputs the drive signals ho, lo, based on the voltage Vvw (i.e., peak power control is performed). Further, immediately after the operation of the switching power supply circuit 10 transitions from the “normal mode” to the “burst mode”, the state of the drive signal output circuit 200 changes from “State A” to “State C” (described later) without going through “State B” (described later).

Meanwhile, when the switching power supply circuit 10 operates in the “burst mode”, except immediately after the switching power supply circuit 10 starts operating in the “burst mode”, the state of the drive signal output circuit 200 repeats transitioning in the order of “State C”, “State D” (described later), “State A” and “State B”.

As such, with the route of the state transition from “State A” to “State D” being changed between the case immediately after transitioning from the “normal mode” to “State A” and the case other than that, it is possible to suppress the output voltage Vout from becoming overvoltage in a time period until the drive signal output circuit 200 enters “State C”.

Returning to FIG. 3, in “State A”, immediately after transitioning from the “normal mode”, in response to the load 11 entering the light load state, the output voltage Vout rising, and the feedback voltage Vfb dropping below the reference voltage Vref1, the drive signal output circuit 200 enters “State C” from “State A” without going through “State B” (described later) (process S20).

“State C” is a state in which the driving of the NMOS transistors 24, 25 in FIG. 1 is stopped. In “State C”, in response to the load 11 entering the heavy load state, the output voltage Vout dropping, and the feedback voltage Vfb exceeding the reference voltage Vref0, which is higher than the reference voltage Vref1, the drive signal output circuit 200 transitions from “State C” to “State D” (process S21). Details will be described later, but in an embodiment of the present disclosure, in order to suppress a rise in the output voltage Vout, the state of the drive signal output circuit 200 changes from “State A” to “State C” without performing soft end operation, immediately after the operation of the switching power supply circuit 10 transitioning to the “burst mode”.

“State D” is a state of outputting the drive signals ho, lo to gradually increase the ON period of each of the NMOS transistors 24, 25 (performing a so-called soft start operation). In “State D”, in response to the soft start period being completed, the state of the drive signal output circuit 200 changes from “State D” to “State A” (process S22).

The operation immediately after transitioning from the “normal mode” to the “burst mode” has been explained so far. Meanwhile, the switching power supply circuit 10 enters “State C” immediately after starting to operate in the “burst mode”, and then the state of the drive signal output circuit 200 will repeat transitioning from “State A” to “State D” in order to intermittently drive the NMOS transistors 24, 25.

Further, when the state of the drive signal output circuit 200 is in “State A” except immediately after transitioning to the “burst mode”, the state of the drive signal output circuit 200 changes from “State A” to “State B”, in response to the output voltage Vout rising and the feedback voltage Vfb dropping below the reference voltage Vref1 (process S23).

“State B” is a state of outputting the drive signals ho, lo to gradually reduce the ON period of each of the NMOS transistors 24, 25 (performing the so-called soft end operation). Then, in “State B”, in response to the time period corresponding to the soft end operation being completed, the state of the drive signal output circuit 200 transitions from “State B” to “State C” (process S24).

As such, when the switching power supply circuit 10 is continuously operating in the “burst mode”, the state of the drive signal output circuit 200 repeats transitioning from “State C” to “State B” through “State D” and “State A”. This makes it possible to suppress noise in the transformer 26 in FIG. 1, when the NMOS transistors 24, 25 in FIG. 1 are driven in the “burst mode”.

Further, in “State A”, in response to the load 11 entering the heavy load state, and the feedback voltage Vfb exceeding the voltage Vb which is higher than the voltage Va, or the voltage Vca exceeding the threshold value Vca_h, the state of the drive signal output circuit 200 transitions from “State A” in the “burst mode” to the “normal mode” so as to operate the switching power supply circuit 10 in the “normal mode” (process S11). Note that the voltage Vb (e.g., 2.5 V) is higher than the voltage Va (e.g., 2.4 V), and the reference voltage Vref0 is lower than the voltage Va. Further, the voltage Vb corresponds to a “third voltage”, and the magnitude of the resonant current when the voltage Vca reaches the threshold value Vca_h corresponds to a “first predetermined amount”.

### ===Output Method of Drive Signals Ho, Lo in “Normal Mode”===

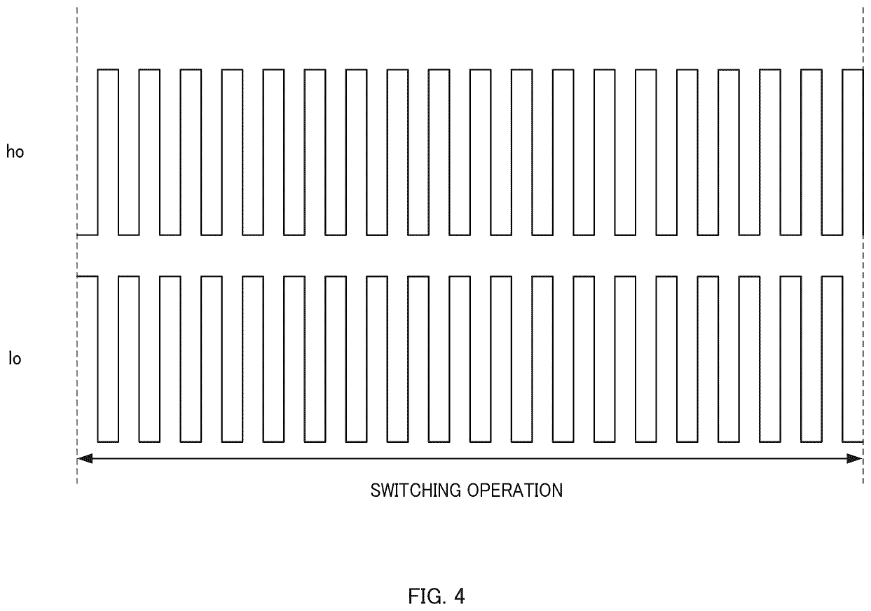

FIG. 4 is a diagram illustrating a driving pattern in the “normal mode”. When the switching power supply circuit 10 is operated in the “normal mode”, the drive signal output circuit 200 outputs the drive signals ho, lo to continuously drive the NMOS transistors 24, 25 without intermittently stopping the switching operation, as illustrated in FIG. 4.

### ===Driving Method in “Normal Mode”===

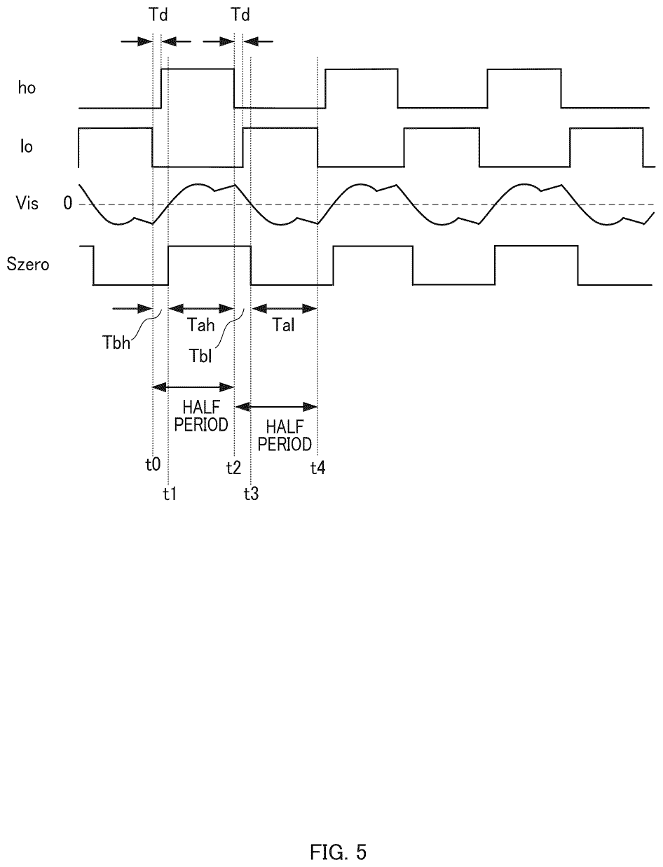

FIG. 5 is a diagram illustrating a driving method in the “normal mode”. When the switching power supply circuit 10 is operated in the “normal mode”, the drive signal output circuit 200 outputs the drive signals ho, lo in a driving method referred to as phase ratio control. Note that the “phase ratio control” refers to a driving method of controlling the switching of the NMOS transistors 24, 25 based on the feedback voltage Vfb and the direction (i.e., polarity) of the resonant current Icr.

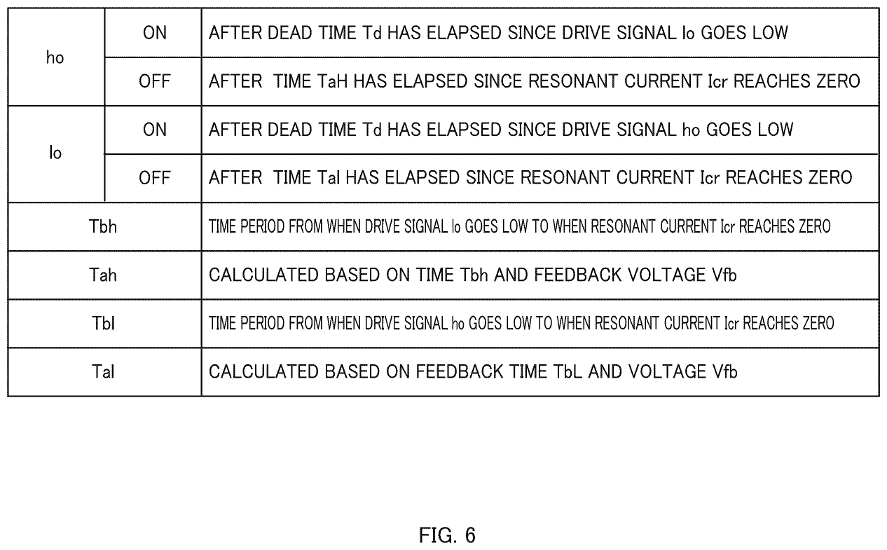

The following describes a specific driving method of the phase ratio control with reference to FIG. 5. In FIG. 5, the drive signal output circuit 200 outputs the low drive signal lo, and then outputs the high drive signal ho after a lapse of a dead time Td, as illustrated in FIG. 6. Similarly, as illustrated in FIG. 6, the drive signal output circuit 200 outputs the low drive signal ho, and then outputs the high drive signal lo after a lapse of the dead time Td. Note that the “dead time” refers to the time period during which both the NMOS transistors 24, 25 are off such that a through-current does not flow between the node to receive the input voltage Vin and the node to receive the ground voltage with both the NMOS transistors 24, 25 being turned on simultaneously.

At time t0, the drive signal output circuit 200 outputs the low drive signal lo. Then, the drive signal output circuit 200 starts measuring a time period Tbh from time t0. Further, the drive signal output circuit 200 obtains the feedback voltage Vfb at time t0. Note that time to indicates the start of a half period.

At time t1, the resonant current Icr reaches zero, and the comparator 109 in FIG. 2 outputs the high signal Szero. In this event, the drive signal output circuit 200 finishes measuring the time period Tbh, and calculates a time period Tah which is a time period until the end of the half period, based on the previously obtained feedback voltage Vfb and the time period Tbh.

At time t2, at which the time period Tah has elapsed since time t1, the drive signal output circuit 200 outputs the low drive signal ho, as illustrated in FIG. 6. Then, the drive signal output circuit 200 starts measuring the time period Tbl from time t2, and also obtains the feedback voltage Vfb at time t2. Note that time t2 indicates the start of the half period.

At time t3, the resonant current Icr reaches zero, and the comparator 109 outputs the low signal Szero. In this event, the drive signal output circuit 200 finishes measuring the time period Tbl and calculates the time period Tal which is a time period until the end of the half period, based on the previously obtained feedback voltage Vfb and the time period Tbl.

At time t4, at which the time period Tal has elapsed since time t3, the drive signal output circuit 200 outputs the low drive signal lo, as illustrated in FIG. 6. The same operation is repeated thereafter.

As has been explained above, the drive signal output circuit 200, for example, calculates the end time of the half period, based on the time period Tbh measured from the time when the low drive signal lo is outputted and the feedback voltage Vfb when the low drive signal lo is outputted. In other words, the drive signal output circuit 200, for example, controls the ratio between the time period Tbh and the time period Tah (i.e., the phase ratio) using the feedback voltage Vfb. By virtue of controlling as such using the feedback voltage Vfb and the time period Tbh varying with the state of the load 11, the drive signal output circuit 200 can maintain the output voltage Vout at the target level while following the change in the state of the load 11.

### ===Output Method of Drive Signals Ho, Lo in “Burst Mode”===

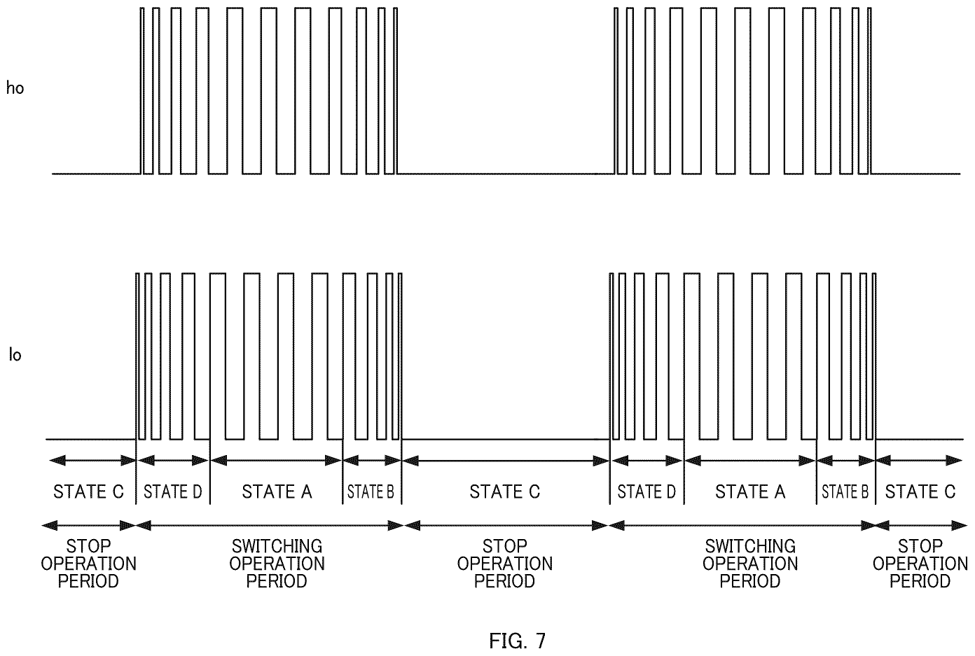

FIG. 7 illustrates a driving pattern in the “burst mode. When the switching power supply circuit 10 is operated in the “burst mode”, the drive signal output circuit 200 outputs the drive signals ho, lo to drive the NMOS transistors 24, 25 intermittently (i.e., in the switching operation period) while providing a stop operation period, as illustrated in FIG. 7. Further, the state of the drive signal output circuit 200 transitions in the order of “State D”, “State A”, and “State B” in the switching operation period, and enters “State C” in which the NMOS transistors 24, 25 are stopped in the stop operation period.

===Driving method in “State D” in “burst mode”===

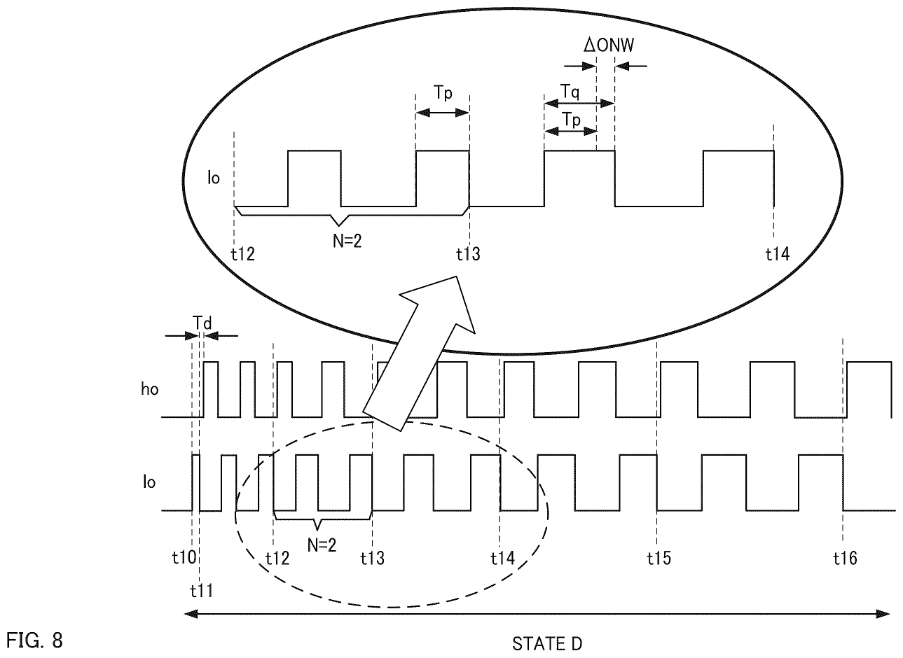

FIG. 8 is a diagram illustrating a driving method in “State D”. When the switching power supply circuit 10 are operated in the “burst mode”, the drive signal output circuit 200 outputs the drive signals ho, lo in the driving method that is referred to as the soft start, in response to the state of the drive signal output circuit 200 entering “State D”. Note that the “soft start” refers to the operation of outputting the drive signals ho, lo each having an ON period that gradually increases according to the amount of change ΔONW every predetermined number of times N (e.g., N=2) as illustrated in an enlarged view in FIG. 8. The following describes the soft start operation with reference to FIG. 8.

At time t10, the state of the drive signal output circuit 200 enters “State D”. Then, the drive signal output circuit 200 outputs the high drive signal lo.

At time t11, at which a predetermined ON period has elapsed since time t10, the drive signal output circuit 200 outputs the low drive signal lo. After time t11, the drive signal output circuit 200 outputs the drive signal lo having an ON period that gradually increases according to the amount of change ΔONW, every predetermined number of times N. Further, the drive signal output circuit 200 outputs the drive signal ho having the same ON period as that of the drive signal lo, alternately with the drive signal lo.

From time t12, at which the drive signal output circuit 200 has outputted the drive signal lo the predetermined number of times N since time t11, the drive signal output circuit 200 increases the ON period of the drive signal lo by the amount of change ΔONW every predetermined number of times N, to thereby output the resultant drive signal lo.

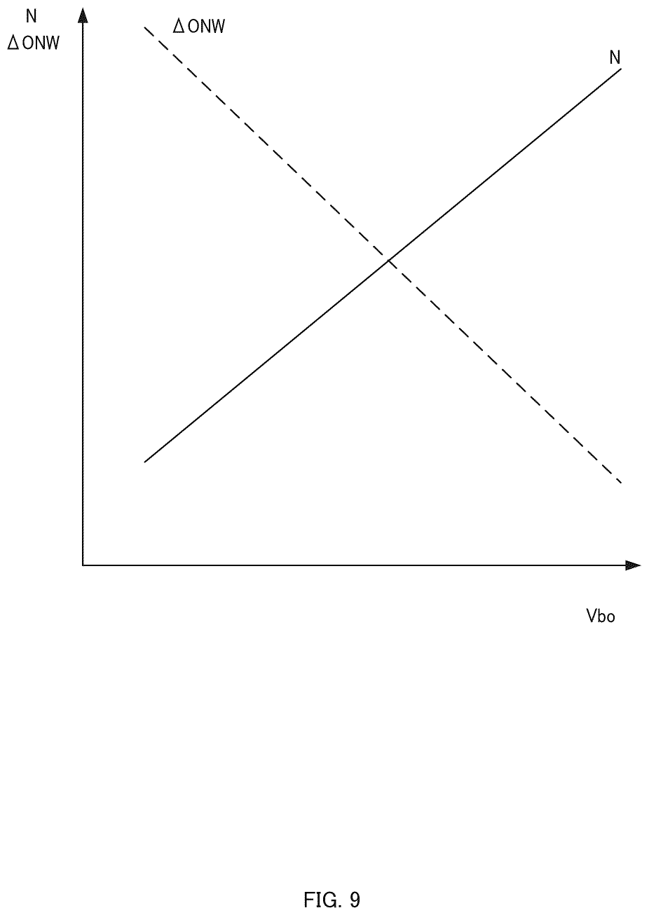

The same operation is repeated from time t12, and this causes the drive signal output circuit 200 to output the drive signals ho, lo that gradually increase the ON period, in the soft start. Further, the predetermined number of times N is set so as to increase with a rise in the voltage Vbo, as given by the solid line in FIG. 9, and the amount of change ΔONW is set so as to decrease with a rise in the voltage Vbo, as given by the dashed line in FIG. 9, similarly. As a result, the drive signal output circuit 200 operates so as to gradually increase the ON period of each of the drive signals ho, lo with a rise in the voltage Vbo, which indicates the input voltage Vin, thereby reducing the effect of the input voltage Vin on the output voltage Vout. Note that “State D” corresponds to a “first state”.

### ===Driving Method in “State A” in “Burst Mode”===

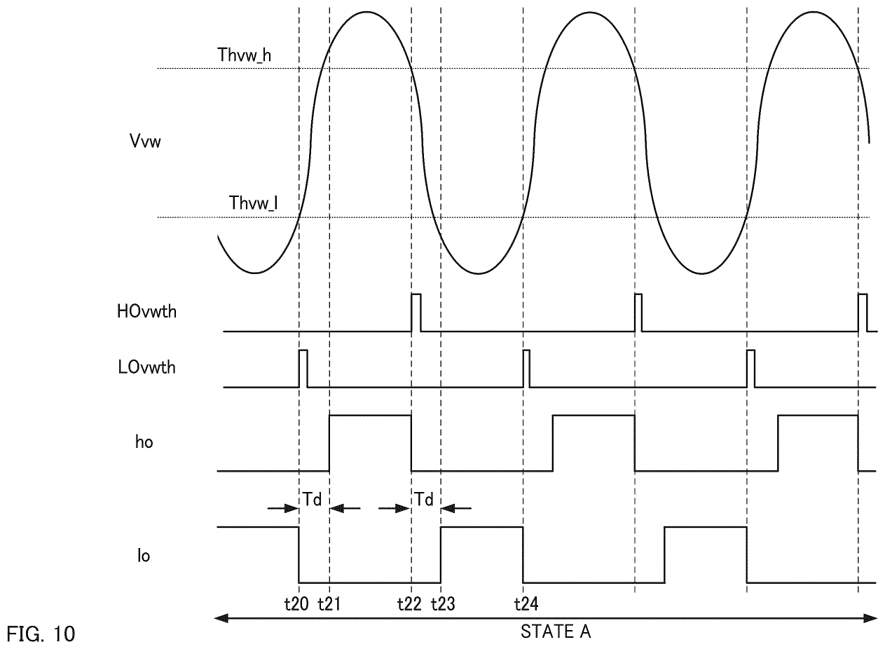

FIG. 10 is a diagram illustrating a driving method in “State A”. When the switching power supply circuit 10 is operated in the “burst mode”, the drive signal output circuit 200 outputs the drive signals ho, lo in the driving method that is referred to as the peak power control, in response to the state of the drive signal output circuit 200 entering “State A”. Note that the “peak power control” refers to the driving method of controlling the switching of the NMOS transistors 24, 25 based on the dead time Td and the result of comparison between the voltage Vvw and a high/low threshold value.

The following describes a specific driving method of the peak power control with reference to FIG. 10. It is assumed that before time t20, the drive signal output circuit 200 outputs the low drive signal ho and the high drive signal lo.

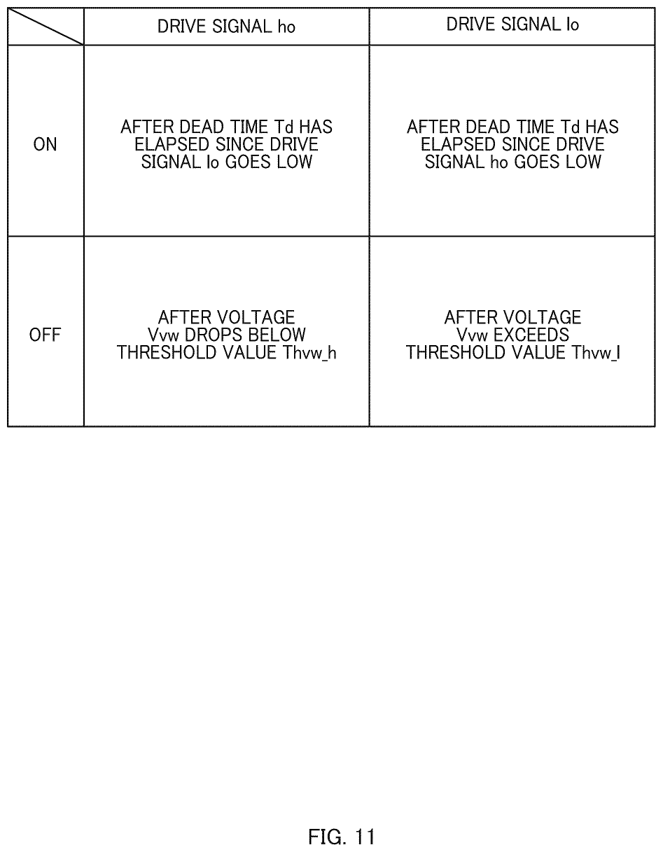

At time t20, at which the voltage Vvw exceeds the threshold value Thvw_l, the comparator circuit 107 outputs the pulse signal LOvwth. As illustrated in FIG. 11, the drive signal output circuit 200 outputs the low drive signal lo upon receiving the pulse signal LOvwth.

At time t21, at which the dead time Td has elapsed since time t20, the drive signal output circuit 200 outputs the high drive signal ho, as illustrated in FIG. 11.

At time t22, at which the voltage Vvw drops below the threshold value Thvw_h, the comparator circuit 107 outputs the pulse signal HOvwth. As illustrated in FIG. 11, the drive signal output circuit 200 outputs the low drive signal ho, upon receiving the pulse signal HOvwth.

At time t23, at which the dead time Td has elapsed since time t22, the drive signal output circuit 200 outputs the high drive signal lo, as illustrated in FIG. 11.

At time t24, at which the voltage Vvw exceeds the threshold value Thvw_l, the comparator circuit 107 outputs the pulse signal LOvwth. As illustrated in FIG. 11, the drive signal output circuit 200 outputs the low drive signal lo upon receiving the pulse signal LOvwth. Thereafter, the same operation is repeated.

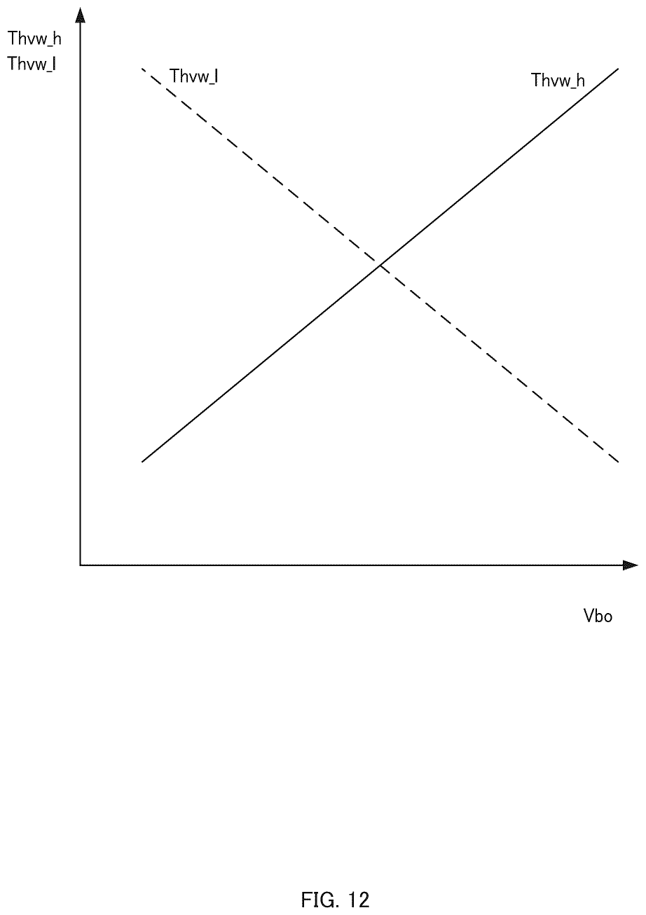

Further, as given by the solid line in FIG. 12, the threshold value Thvw_h is set so as to increase with a rise in the voltage Vbo. Meanwhile, as given by the dashed line in FIG. 12, the threshold value Thvw_l is set so as to decrease with a rise in the voltage Vbo. Thus, in response to the voltage Vbo rising, the drive signal output circuit 200 reduces the ON period of each of the drive signals ho, lo, to thereby reduce the effect of the input voltage Vin on the output voltage Vout. Note that “State A” corresponds to a “third state”.

### ===Driving Method in “State B” in “Burst Mode”===

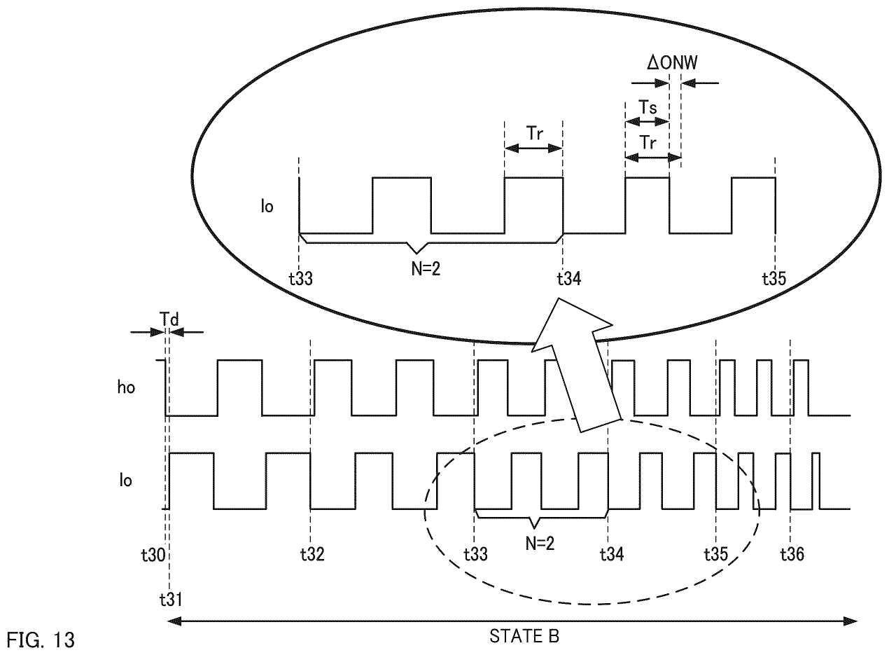

FIG. 13 is a diagram illustrating a driving method in “State B”. When the switching power supply circuit 10 is operated in the “burst mode”, the drive signal output circuit 200 outputs the drive signals ho, lo in the driving method that is referred to as the soft end, in response to the state of the drive signal output circuit 200 entering “State B”. Note that the “soft end” is the operation of outputting the drive signals ho, lo each having an ON period that gradually decreases according to the amount of change ΔONW every predetermined number of times N (e.g., N=2) as illustrated in an enlarged view in FIG. 13. The following describes the soft end operation with reference to FIG. 13.

At time t30, at which the drive signal output circuit 200 outputs the low drive signal ho, the state of the drive signal output circuit 200 enters “State B”.

At time t31, at which the dead time Td has elapsed since time t30, the drive signal output circuit 200 outputs the high drive signal lo. Thereafter, the drive signal output circuit 200 outputs the drive signal lo having an ON period that gradually decreases according to the amount of change ΔONW every predetermined number of times N (e.g., twice). Further, the drive signal output circuit 200 outputs the drive signal ho having the same ON period as that of the drive signal lo, alternately with the drive signal lo.

This causes the drive signal output circuit 200 to output the drive signals ho, lo each having the ON period that gradually decreases, in the soft end. As in the case of the soft start, the predetermined number of times N is set so as to increase with a rise in the voltage Vbo, as given by the solid line in FIG. 9, and the amount of change ΔONW is set so as to decrease with a rise in the voltage Vbo, as given by the dashed line in FIG. 9, similarly. This causes the drive signal output circuit 200 to operate so as to reduce the ON period of each of the drive signals ho, lo little by little with a rise in the voltage Vbo, which indicates the input voltage Vin, to thereby reduce the effect of the input voltage Vin on the output voltage Vout. Note that “State B” corresponds to a “second state”.

===Operation Immediately after Transition from “Normal Mode” to “Burst Mode”===

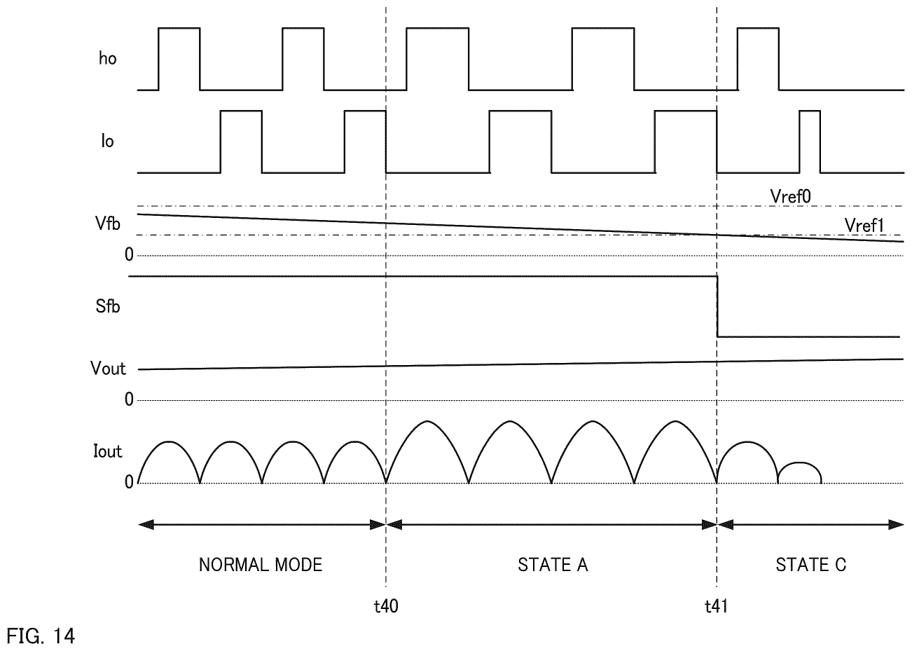

FIG. 14 illustrates operation waveforms immediately after shifting from the “normal mode” to the “burst mode.

At time t40, at which the load 11 enters the light load state, the feedback voltage Vfb drops below the voltage Va, and the predetermined time period Ta has elapsed with the voltage Vca remaining lower than the threshold value Vca_l, the state of the drive signal output circuit 200 changes from the “normal mode” to “State A” in the “burst mode.

At time t41, at which the output voltage Vout rises and the feedback voltage Vfb drops below the reference voltage Vref1, the comparator 103 outputs the low signal Sfb. The state of the drive signal output circuit 200 that has received the low signal Sfb enters “State C”. Thus, the drive signal output circuit 200 stops driving the NMOS transistors 24, 25, after outputting the drive signals ho, lo each having a predetermined ON period, as a final process.

Accordingly, the drive signal output circuit 200 stops driving the NMOS transistors 24, 25, after the output voltage Vout rises to some extent and the feedback voltage Vfb drops below the reference voltage Vref1. This causes the drive signal output circuit 200 not to perform the soft end, thereby being able to suppress overvoltage of the output voltage Vout.

### ==Driving Pattern in Switching Operation Period in “Burst Mode”===

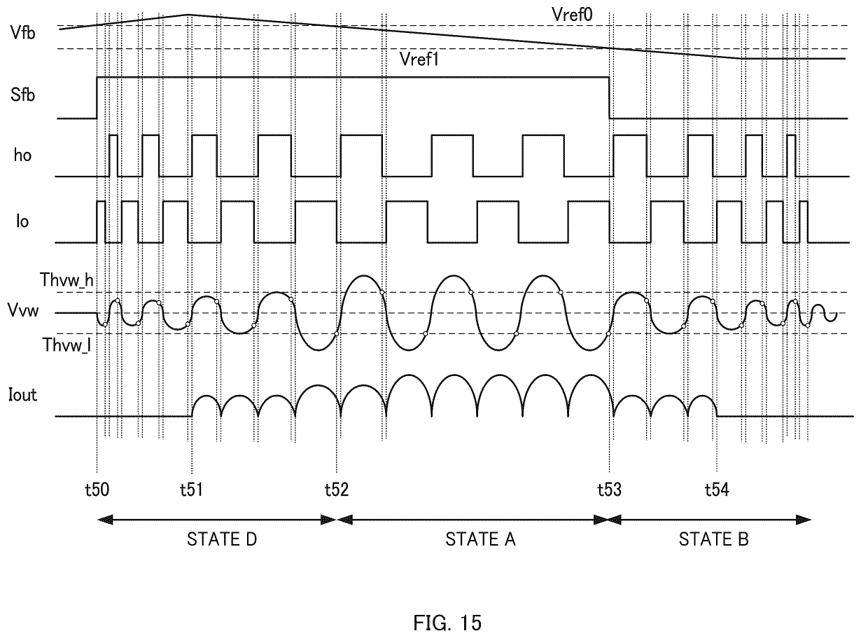

FIG. 15 is a diagram illustrating a driving pattern in the switching operation period in the “burst mode”.

At time t50, at which the output voltage Vout drops, the feedback voltage Vfb exceeds the reference voltage Vref0, and the comparator 103 outputs the high signal Sfb, the state of the drive signal output circuit 200 enters “State D”. Thus, the drive signal output circuit 200 starts the soft start, outputs the drive signal lo, and then outputs the drive signal ho. Further, the drive signal output circuit 200 gradually increases the ON period of each of the NMOS transistors 24, 25. However, until time t51, a disabled switching period is entered, and the output current Iout does not flow on the secondary side of the transformer 26.

At time t52, at which the soft start is completed, the state of the drive signal output circuit 200 enters “State A”. Thus, the drive signal output circuit 200 performs the peak power control, to output the drive signals ho, lo according to the timing determined by the voltage Vvw. Further, time t52 is determined based on the timing at which the ON period used in “State A” becomes shorter than the ON period used in “State D”.

At time t53, at which the output voltage Vout rises, the feedback voltage Vfb drops below the reference voltage Vref1, and the comparator 103 outputs the low signal Sfb, the state of the drive signal output circuit 200 enters “State B”. Thus, the drive signal output circuit 200 starts the soft end, and outputs the drive signals ho, lo each having the ON period that gradually decreases.

Further, as in the case of the soft start, in response to the ON period of each of the drive signals ho, lo decreasing, the disabled switching period is entered, and the output current Iout does not flow to the secondary side of the transformer 26, from time t54, for example.

Then, in response to the soft end being completed, the state of the drive signal output circuit 200 enters “State C” and the drive signal output circuit 200 stops driving the NMOS transistors 24, 25. Further, from time t53, in response to the ON period used in “State B” becoming shorter than the ON period used in “State A”, the NMOS transistors 24, 25 are driven by the drive signals ho, lo based on the soft end. However, when the feedback voltage Vfb drops below the reference voltage Vref1, the ON period in “State B” is often shorter than the ON period in “State A”. The above description is given assuming that the state transitions from “State A” to “State B” at time t53.

### ===Operation of Control IC 40a Based on Feedback Voltage Vfb in “Burst Mode”===

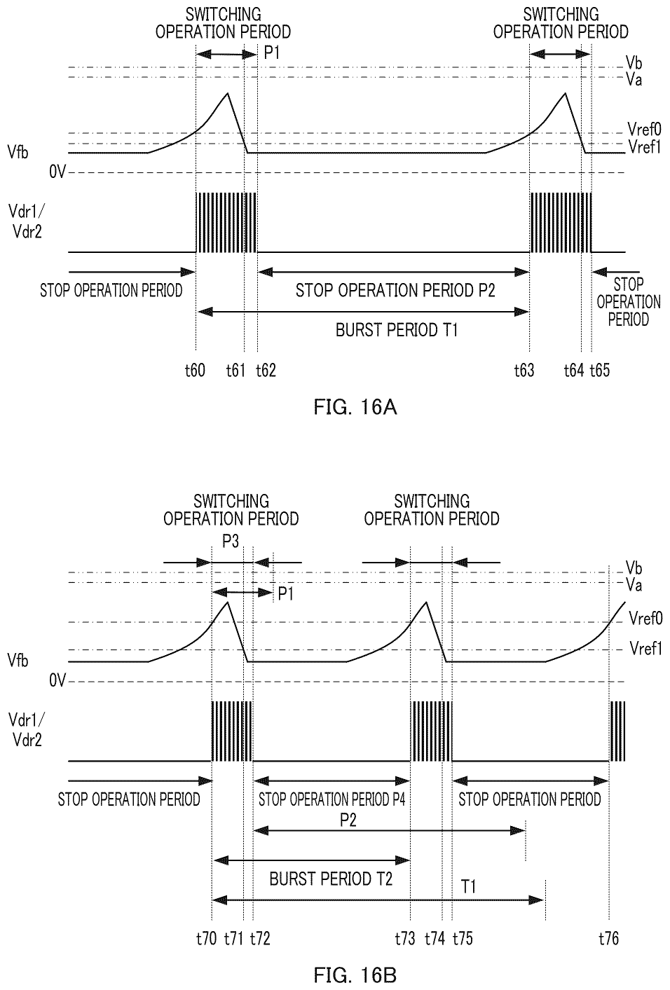

FIG. 16A is a diagram illustrating an operation of the control IC 40a in the “burst mode”.

At time t60, in response to the feedback voltage Vfb rising and exceeding the reference voltage Vref0 with a drop in the output voltage Vout, the control IC 40a starts driving the NMOS transistors 24, 25. According to the driving of the NMOS transistors 24, 25, the output voltage Vout, which had dropped, starts to rise, resulting in the feedback voltage Vfb rising and then dropping.

At time t61, in response to the feedback voltage Vfb dropping below the reference voltage Vref1 with a rise in the output voltage Vout, the control IC 40a stops the peak power control and enters the soft end.

At time t62, at which the soft end is completed and a switching operation period P1 has elapsed since time t60, the control IC 40a stops driving the NMOS transistors 24, 25. Thereafter, when the feedback voltage Vfb is lower than the reference voltage Vref0, the control IC 40a stops driving the NMOS transistors 24, 25. This time period is defined as a stop operation period P2. Further, the time period obtained by combining the switching operation period P1 and the stop operation period P2 will be referred to as a burst period T1. Then, the same operation is repeated from time t63.

FIG. 16B is a diagram illustrating an operation of the control IC 40a in the “burst mode”. Note that the reference voltage Vref0 in FIG. 16B is higher than the reference voltage Vref0 in FIG. 16A, but is lower than the voltages Va (e.g., 2.4 V) and Vb (e.g., 2.5 V) used in the transition between the “normal mode” and the “burst mode”. Further, the operation of the control IC 40a from t70 to t72 is the same as the operation from t60 to t62 in FIG. 16A, and the same operation is repeated from time t73.

Further, in FIG. 16B, the reference voltage Vref0 is higher than in FIG. 16A, and a switching operation period P3, in which the control IC 40a drives the NMOS transistors 24, 25, is shorter than the switching operation period P1. Thus, it becomes difficult for the switching power supply circuit 10 to sufficiently raise the output voltage Vout. Accordingly, the output voltage Vout drops again within a short period of time, resulting in a stop operation period P4 being shorter than the stop operation period P2. Thus, a burst period T2 is also shorter than the burst period T1.

Further, in order to adjust the operation of the control IC 40a in the “burst mode” as such, it was necessary to adjust the circuit constant of an element for generating the feedback voltage Vfb included in the switching power supply circuit 10. However, in actuality, the circuit constant of an external component varies and a circuit configuration is complex. Thus, it was difficult to adjust the generation of the feedback voltage Vfb by adjusting the circuit constant.

Meanwhile, as in an embodiment of the present disclosure, with the level of the reference voltage Vref0 being adjusted to any one of the predetermined multiple voltage levels, the operation of the control IC 40a in the “burst mode” can be easily adjusted without adjusting the generation of the feedback voltage Vfb as described above.

### Modifications

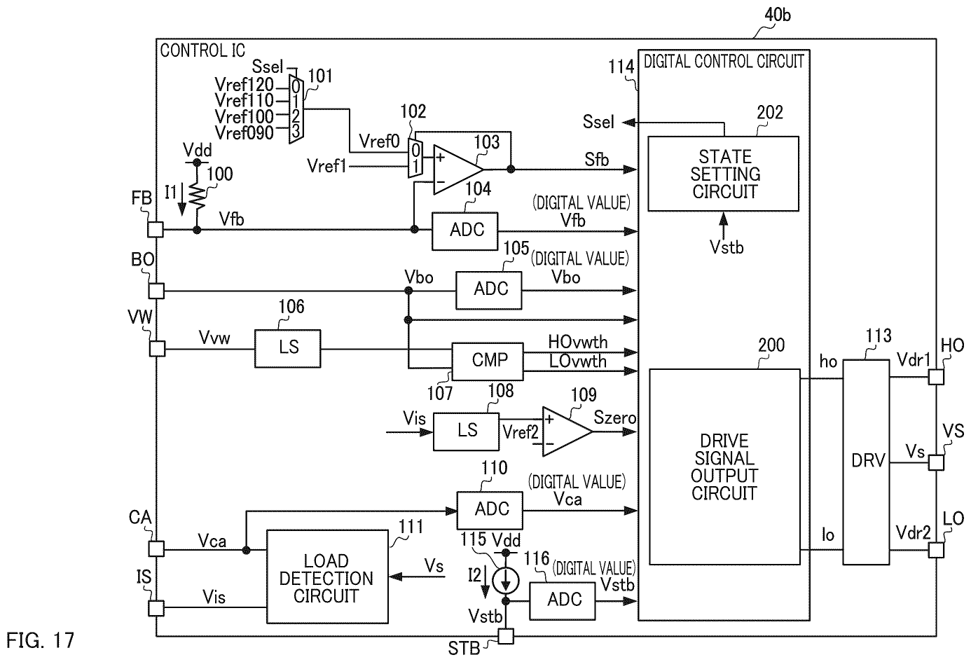

FIG. 17 is a diagram illustrating an example of a control IC 40b. The control IC 40b is the integrated circuit that drives the NMOS transistors 24, 25, based on the state that transitions according to the voltage applied to each of the terminals, as in the control IC 40a. The control IC 40b includes the resistor 100, the selectors 101 and 102, the comparators 103 and 109, the analog-to-digital converter circuits (ADCs) 104, 105, and 110, and an ADC 116, the level shifter circuits (LSs) 106 and 108, the comparator circuit (CMP) 107, the load detection circuit 111, a digital control circuit 114, the driver circuit (DRV) 113, and a constant current source 115. Note that the terminals VCC and GND are omitted here for convenience.

The digital control circuit 114 outputs the drive signals ho, lo and the signal Ssel, based on a plurality of signals, such as the signal Sfb and the like, and digital values. The digital control circuit 114 includes the drive signal output circuit 200 and a state setting circuit 202.

The state setting circuit 202 outputs the signal Ssel, based on a voltage Vstb generated at the terminal STB, which will be described later in detail.

The constant current source 115 supplies a predetermined current I2 to the resistor 58 (see FIG. 1) connected to the terminal STB. The voltage Vstb generated at the terminal STB varies with the resistance value of the resistor 58, and the state setting circuit 202 outputs the signal Ssel, based on the level of the voltage Vstb. Accordingly, the selector 101 adjusts the level of the reference voltage Vref0, based on the voltage Vstb. Note that the constant current source 115 corresponds to a “constant current circuit”.

The analog-to-digital converter circuit (ADC) 116 converts the voltage Vstb at the terminal STB into a digital value, to output a resultant. The voltage Vstb converted into the digital value is used for the state setting circuit 202 to output the signal Ssel.

### Other Modifications

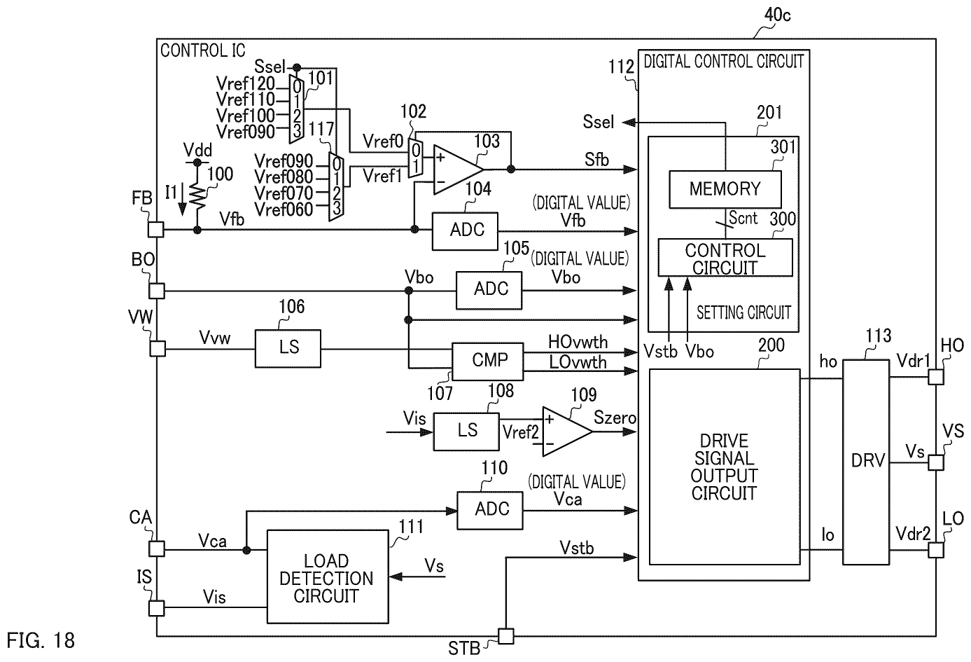

Further, in the control IC 40a in FIG. 2 and the control IC 40b in FIG. 17, the selector 101 is used, but as illustrated in FIG. 18, a selector 117 may be added to adjust both the reference voltages Vref0 and Vref1 to predetermined voltage levels.

The selector 117 adjusts the level of the reference voltage Vref1 to any one of the levels of the reference voltages Vref090, Vref080, Vref070, and Vref060 outputted based on the signal Ssel from the digital control circuit 112. Specifically, the selector 117 adjusts the reference voltage Vref1 to the reference voltage Vref090, when signal Ssel is “0”. Further, the selector 117 adjusts the reference voltage Vref1 to the reference voltages Vref080, Vref070, and Vref060, respectively, when the signal Ssel is “1,” “2,” and “3,” respectively. Note that the reference voltage Vref1 is used by the comparator 103 as a lower reference voltage. Further, by way of example, the reference voltage Vref090 is 0.9 V, the reference voltage Vref080 is 0.8 V, the reference voltage Vref070 is 0.7 V, and the reference voltage Vref060 is 0.6 V. Note that the selector 117 corresponds to a “second adjustment circuit”.

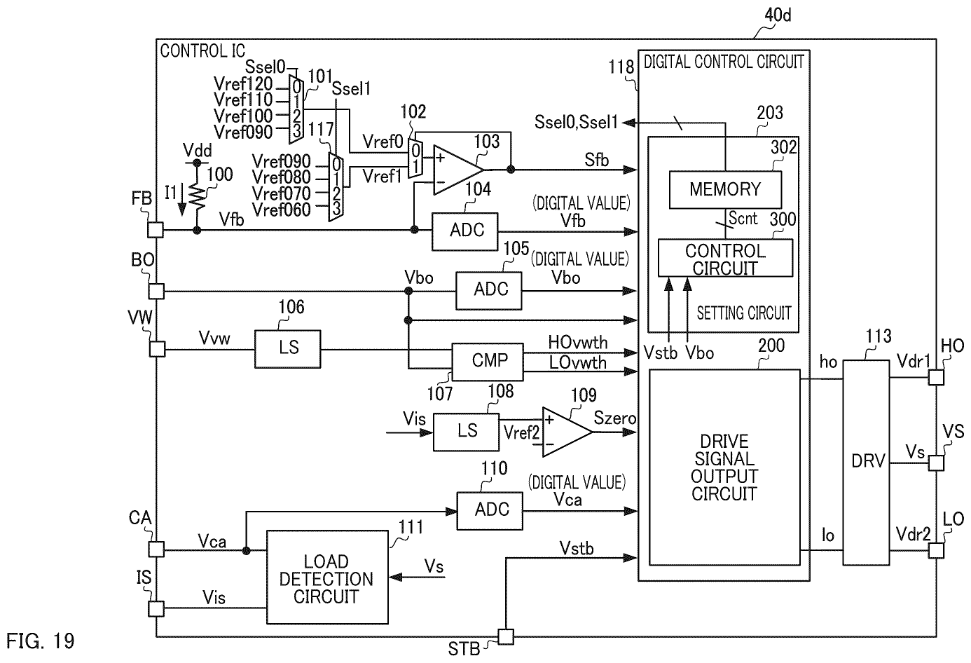

In the control IC 40c of FIG. 18, the selectors 101 and 117 adjust the reference voltages Vref0 and Vref1, respectively, based on the same signal Ssel. Meanwhile, as illustrated in FIG. 19, the selectors 101 and 117 may use two different signals Ssel0 and Ssel1 to adjust the reference voltages Vref0 and Vref1, respectively. Further, in this case, the setting circuit 203 receives data indicating the level of the reference voltage Vref1, and the selector 117 adjusts the level of the reference voltage Vref1, based on the data indicating the level of the reference voltage Vref1. Note that the data indicating the level of the reference voltage Vref1 corresponds to a “second data”.

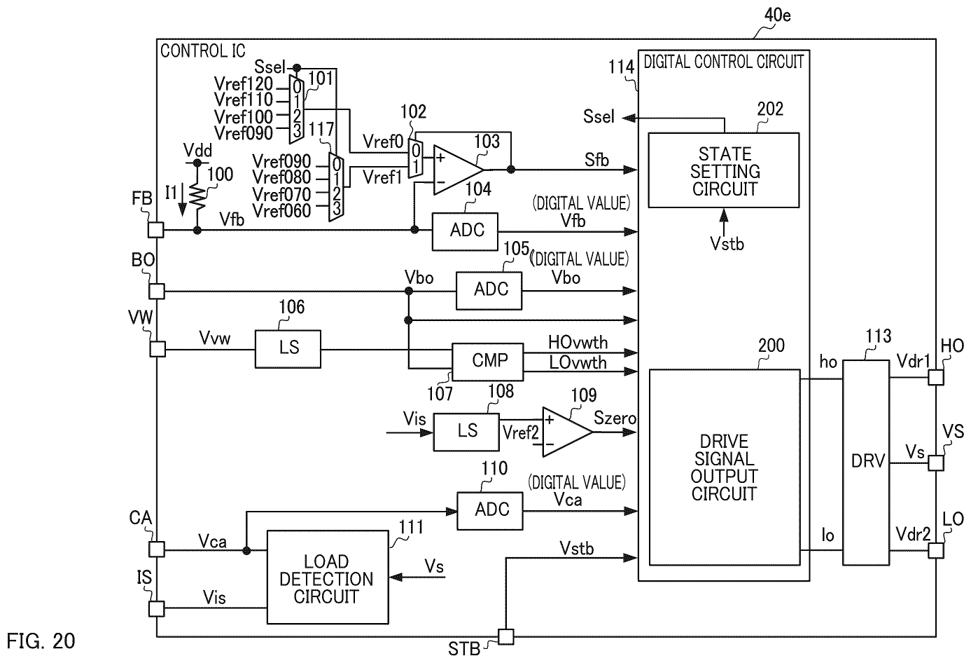

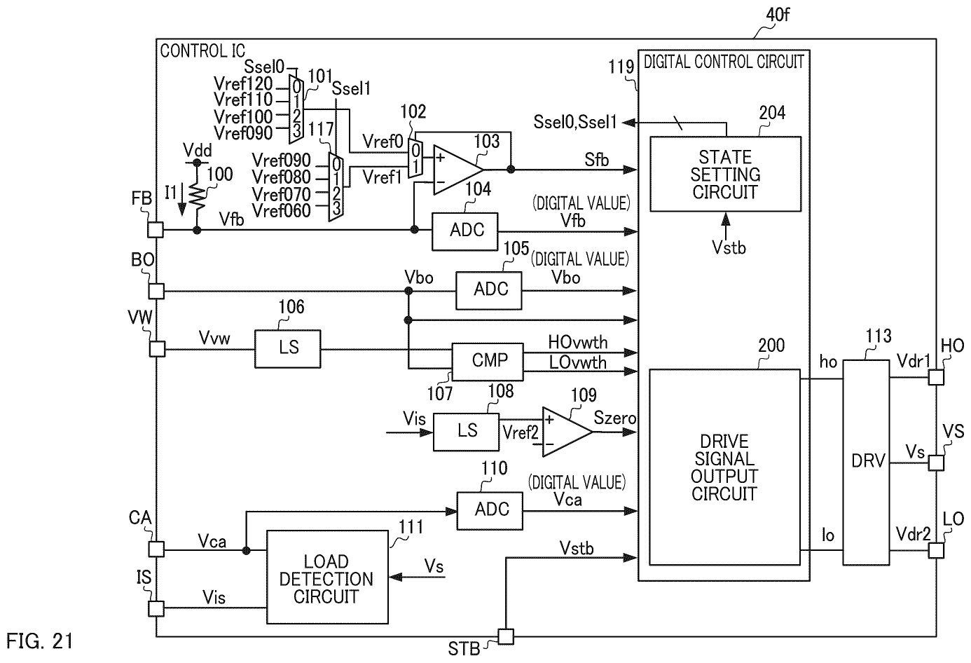

Further, when the state setting circuit 202 is used as in the control IC 40e in FIG. 20, the state setting circuit 202 outputs the signal Ssel, based on the voltage Vstb. Further, when a state setting circuit 204 is used as in a control IC 40f in FIG. 21, the state setting circuit 204 outputs signals Ssel0 and Ssel1, based on the voltage Vstb.

Further, in an embodiment of the present disclosure, the switching power supply circuit 10 is operated in the “burst mode” under the conditions of the voltage Vca and the feedback voltage Vfb. But the switching power supply circuit 10 may be operated in the “burst mode” under the condition of only the feedback voltage Vfb. Specifically, the drive signal output circuit 200 may output the drive signals ho, lo to operate the switching power supply circuit 10 in the “burst mode”, in response to the feedback voltage Vfb reaching the voltage Va. Even in such a configuration, the same effect as in an embodiment of the present disclosure can be obtained.

### SUMMARY

The switching power supply circuit 10 according to an embodiment of the present disclosures has been described above. The control IC 40a includes the selector 101 and the drive signal output circuit 200. The feedback voltage Vfb is compared with the reference voltage Vref0 from the selector 101 and the reference voltage Vref1, to determine the operation when the switching power supply circuit 10 operates in the “burst mode”. In this event, the reference voltage Vref0 is adjusted to a plurality of predetermined levels, thereby facilitating the adjustment of the operation in the “burst mode” as illustrated in FIGS. 16A and 16B. This makes it possible to provide the switching control circuit capable of easily changing the operation of a DC-DC converter in the burst mode.

Further, the drive signal output circuit 200 outputs the drive signals ho, lo to cause the switching power supply circuit 10 to operate in the “normal mode”, in response to the feedback voltage Vfb reaching the voltage Vb. Meanwhile, the drive signal output circuit 200 outputs the drive signals ho, lo to cause the switching power supply circuit 10 to operate in the “burst mode”, in response to the feedback voltage Vfb reaching the voltage Va. Further, the reference voltage Vref0 is lower than the voltage Va. This enables the switching power supply circuit 10 to operate in the “burst mode”, when the output voltage Vout is high.

Further, the control IC 40a includes the load detection circuit 111, and the drive signal output circuit 200 outputs the drive signals ho, lo to cause the switching power supply circuit 10 to operate in the “normal mode”, in response to the voltage Vca exceeding the voltage Vca_h. Meanwhile, in response to the voltage Vca dropping below the voltage Vca_l and the feedback voltage Vfb reaching the voltage Va, the drive signal output circuit 200 outputs the drive signals ho, lo to cause the switching power supply circuit 10 to operate in the “burst mode”. This causes the switching power supply circuit 10 to transition to the “normal mode” or the “burst mode” more appropriately.

Further, the drive signal output circuit 200 is in “State D” and “State B” when the switching power supply circuit 10 operates in the “burst mode”. This suppresses noise from the transformer 26 when the NMOS transistors 24, 25 are driven intermittently.

Further, when the switching power supply circuit 10 operates in the “burst mode”, the state of the drive signal output circuit 200 transitions from “State A” to “State D”. Then, in the switching operation period, the state of the drive signal output circuit 200 transitions in the order of “State D”, “State A”, and “State B”. In this event, the state of the drive signal output circuit 200 transitions from “State D” (soft start) to “State A” (peak power control) at the timing at which the ON period in “State A” becomes shorter than the ON period in “State D”. This provides continuity of operation, prevents noise, and contributes to stability of the system of the switching power supply circuit 10.

Further, the drive signal output circuit 200 controls the switching of the NMOS transistors 24, 25 so as to have the “switching operation period” of transitioning from “State D” to “State B” through “State A” and the “stop operation period” of stopping the switching of the NMOS transistors 24, 25, when the power supply circuit 10 operates in the “burst mode”. This enables the control IC 40a to output appropriate drive signals ho, lo according to the state of the load 11.

Further, the “stop operation period” is included in a time period from the completion of “State B” to the start of “State D”. This reduces the power consumption of the switching power supply circuit 10, when the output voltage Vout is high and it is not needed to send much power to the secondary side of the switching power supply circuit 10.

Further, the state of the drive signal output circuit 200 transitions from “State A” (peak power control) to “State B” (soft end) at the timing at which the ON period in “State B” becomes shorter than the ON period in “State A”. This provides continuity of operation, prevents noise, and contributes to stability of the system of the switching power supply circuit 10.

Further, the control IC 40a includes the setting circuit 201. The selector 101 adjusts the level of the reference voltage Vref0, based on the data received by the setting circuit 201. This makes it possible to adjust the reference voltage Vref0 in the manufacturing stage, thereby facilitating the manufacturing of the switching power supply circuit 10.

Further, the control IC 40d includes the selector 117. This makes it possible to adjust the level of the reference voltage Vref1, thereby being able to more easily change the operation of the switching power supply circuit 10 in the “burst mode”.

Further, the setting circuit 201 receives the data indicating the level of the reference voltage Vref1. Then, the selector 117 adjusts the level of the reference voltage Vref1, based on the data indicating the level of the reference voltage Vref1. This makes it possible to adjust the reference voltage Vref1 in the manufacturing stage, thereby facilitating the manufacturing of the switching power supply circuit 10.

Further, the control IC 40b is an integrated circuit including the terminal STB and the constant current source 115, and the selector 101 adjusts the level of the reference voltage Vref0, based on the voltage of the resistor 58 connected to the terminal STB. This makes it possible to more easily change the operation of the control IC 40b in the “burst mode”, when the switching power supply circuit 10 is designed.

Further, the control IC 40a includes the comparator 109, and the drive signal output circuit 200 outputs the drive signals ho, lo, based on the signal Szero from the comparator 109 and the feedback voltage Vfb, when the switching power supply circuit 10 is operating in the “normal mode”. This enables the control IC 40a to switch the NMOS transistors 24, 25 using the “phase ratio control”.

The present disclosure is directed to provision of a switching control circuit capable of easily change an operation of a DC-DC converter in a burst mode.

According to the present disclosure, it is possible to provide a switching control circuit capable of easily changing an operation of a DC-DC converter in a burst mode.

Embodiments of the present disclosure described above are simply to facilitate understanding of the present disclosure and are not in any way to be construed as limiting the present disclosure. The present disclosure may variously be changed or altered without departing from its essential features and encompass equivalents thereof.

What is claimed is:

1. A switching control circuit for controlling a power supply circuit that generates an output voltage at a target level on a secondary side from an input voltage thereof, the power supply circuit including
a transformer including a primary coil, a secondary coil, and an auxiliary coil,
a first transistor and a second transistor that are configured to control a current of the primary coil, and
a first capacitor that forms a resonant circuit with the primary coil,
the switching control circuit being configured to control switching of the first transistor and the second transistor, the switching control circuit comprising:
a comparator circuit configured to compare each of a first voltage and a second voltage lower than the first voltage, with a feedback voltage corresponding to the output voltage;
a first adjustment circuit configured to adjust a level of the first voltage; and
a drive signal output circuit configured to
output a drive signal to operate the power supply circuit in a normal mode, in response to a state of a load of the power supply circuit entering a heavy-load state, and
output the drive signal to operate the power supply circuit in a burst mode, in response to the state of the load entering a light-load state, wherein
the drive signal output circuit
enters a first state of outputting the drive signal to gradually increase an ON period of each of the first transistor and the second transistor, in response to the feedback voltage exceeding the first voltage, and
enters a second state of outputting the drive signal to gradually reduce the ON period of each of the first transistor and the second transistor, in response to the feedback voltage dropping below the second voltage.

2. The switching control circuit according to claim 1, wherein
the drive signal output circuit is further configured to
output the drive signal to operate the power supply circuit in the normal mode, in response to the feedback voltage reaching a third voltage, and
output the drive signal to operate the power supply circuit in the burst mode, in response to the feedback voltage reaching a fourth voltage lower than the third voltage; and
the first voltage is lower than the fourth voltage.

3. The switching control circuit according to claim 2, further comprising:
a resonant current amount detection circuit configured to detect a magnitude of a resonant current flowing through the resonant circuit, wherein
in response to the resonant current amount detection circuit detecting that the magnitude of the resonant current is equal to a first predetermined amount, the drive signal output circuit outputs the drive signal to cause the power supply circuit to operate in the normal mode, and
in response to the resonant current amount detection circuit detecting that the magnitude of the resonant current is equal to a second predetermined amount, and the feedback voltage reaching the fourth voltage, the drive signal output circuit outputs the drive signal to cause the power supply circuit to operate in the burst mode.

4. The switching control circuit according to claim 1, wherein the drive signal output circuit enters the first state and the second state when the power supply circuit operates in the burst mode.

5. The switching control circuit according to claim 1, wherein
the drive signal output circuit is further configured to operate in a third state between the first state and the second state, the third state being a state of outputting the drive signal to set the ON period of each of the first transistor and the second transistor according to a voltage of the auxiliary coil, and
the drive signal output circuit transitions from the first state to the third state, in response to the ON period of each of the first transistor and the second transistor determined according to the voltage of the auxiliary coil becoming shorter than the ON period of each of the first transistor and the second transistor in the first state.

6. The switching control circuit according to claim 5, wherein the drive signal output circuit controls switching of the first transistor and the second transistor so as to have
a switching operation period of transitioning from the first state to the second state through the third state, and
a stop operation period of stopping the switching the first transistor and the second transistor,
when the power supply circuit operates in the burst mode.

7. The switching control circuit according to claim 6, wherein the stop operation period is included in a time period from completion of the second state to start of the first state.

8. The switching control circuit according to claim 5, wherein the drive signal output circuit transitions from the third state to the second state, in response to the ON period of each of the first transistor and the second transistor in the second state becoming shorter than the ON period of each of the first transistor and the second transistor determined according to a voltage of the auxiliary coil.

9. The switching control circuit according to claim 1, further comprising:
a setting circuit configured to receive first data indicating the level of the first voltage, wherein
the first adjustment circuit adjusts the level of the first voltage, based on the first data.

10. The switching control circuit according to claim 9, further comprising:
a second adjustment circuit configured to adjust a level of the second voltage.

11. The switching control circuit according to claim 10, wherein
the setting circuit receives second data indicating the level of the second voltage, and
the second adjustment circuit adjusts the level of the second voltage, based on the second data.

12. The switching control circuit according to claim 1, wherein
the switching control circuit is an integrated circuit including
a first terminal to which a resistor is connected, and
a constant current circuit configured to supply a predetermined current to the resistor, and
the first adjustment circuit adjusts the level of the first voltage, based on a voltage of the resistor.

13. The switching control circuit according to claim 12, further comprising a second adjustment circuit configured to adjust a level of the second voltage.

14. The switching control circuit according to claim 13, wherein the second adjustment circuit adjusts the level of the second voltage, based on a voltage of the resistor.

15. The switching control circuit according to claim 1, further comprising
a detection circuit configured to detect a resonant current flowing through the resonant circuit, wherein
the drive signal output circuit outputs the drive signal, based on a result of detection of the detection circuit and the feedback voltage, when the power supply circuit is operating in the normal mode.

16. A power supply circuit configured to generate an output voltage at a target level on a secondary side from an input voltage thereof, the power supply circuit comprising:
a transformer including a primary coil, a secondary coil, and an auxiliary coil;
a first transistor and a second transistor that are configured to control a current of the primary coil;
a first capacitor forming a resonant circuit with the primary coil; and
a switching control circuit configured to control switching of the first transistor and the second transistor, wherein
the switching control circuit includes
a comparator circuit configured to compare each of a first voltage and a second voltage lower than the first voltage, with a feedback voltage corresponding to the output voltage,
a first adjustment circuit configured to adjust a level of the first voltage, and
a drive signal output circuit configured to
output a drive signal to operate the power supply circuit in a normal mode, in response to a state of a load of the power supply circuit entering a heavy-load state, and
output the drive signal to operate the power supply circuit in a burst mode, in response to the state of the load entering a light-load state; and
the drive signal output circuit
enters a first state of outputting the drive signal to gradually increase an ON period of each of the first transistor and the second transistor, in response to the feedback voltage exceeding the first voltage, and
enters a second state of outputting the drive signal to gradually reduce the ON period of each of the first transistor and the second transistor, in response to the feedback voltage dropping below the second voltage.
